(19) United States
(12) Patent Application Publication
(10) Pub. No.: US 2004/0012680 A1
(43) Pub. Date: Jan. 22, 2004

(54) Detachable telescope camera

(76) Inventor: Chia Jung Wu, Chia I Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/197,435

(22) Filed: Jul. 18, 2002

(51) Int. Cl. H04N 5/225

(52) U.S. Cl. 348/207.99

(57) ABSTRACT

A detachable telescope camera is constructed to include a telescope unit, for example, a binoculars, a digital camera, and detachable coupling means adapted for detachably securing the digital camera to the binoculars at a bottom side for taking photos of the field viewed through the telescope unit.

### BACKGROUND OF THE INVENTION

1. Field of the Invention

The present invention relates to telescopes and digital cameras and, more specifically, to a telescope camera, which comprises a binoculars and a digital camera detachably fastened to the binoculars at a bottom side for use with the binoculars.

2. Description of the Prior Art

When viewing the image of the wild field or a sports game at a distance, a telescope, binoculars, or opera glasses may be used. Further, following fast development of digital technology, digital cameras have become more and more popularly used instead of conventional mechanical cameras. However, due to limited focusing distance, a digital camera cannot be used to view an object at a distance. Therefore, there is desirable to provide a telescope camera that enables the user to view the image of an object clearly at a distance and to simultaneously take the photos of the object in view.

### SUMMARY OF THE INVENTION

The present invention has been accomplished under the circumstances in view. It is the main object of the present invention to provide a detachable telescope camera, which combines a binoculars with a digital camera so that the user can take photos with the digital camera when viewing the field at a distance with the binoculars. According to the present invention, a detachable coupling structure is provided for detachable securing the digital camera to the binoculars at the bottom, so that the user can use the digital camera with the binoculars. If desired, the user can separate the digital camera from the binoculars for use separately.

### BRIEF DESCRIPTION OF THE DRAWINGS

FIG. 1 is an exploded view of a detachable telescope camera according to the present invention.

FIG. 2 is an elevational assembly view of the detachable telescope camera according to the present invention.

FIG. 3 is a sectional view of the detachable telescope camera according to the present invention.

### DETAILED DESCRIPTION OF THE PREFERRED EMBODIMENT

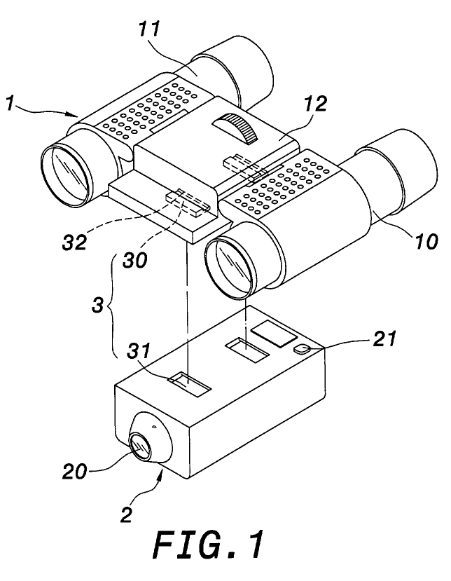

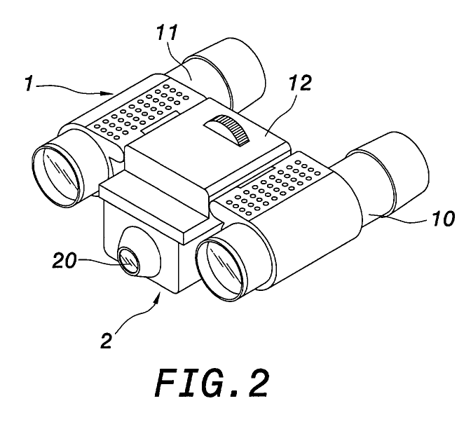

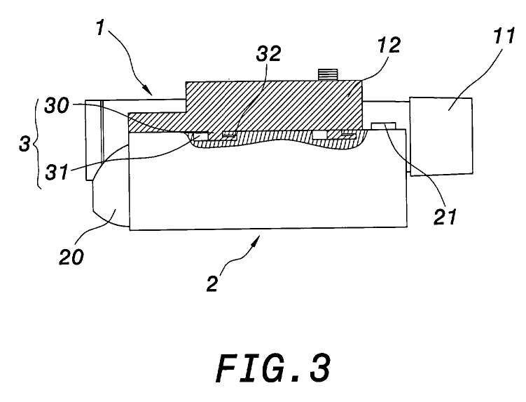

Referring to FIGS. 1, 2, and 3, a detachable telescope camera in accordance with the present invention is shown comprised of a telescope unit 1, a digital camera 2, and a detachable coupling structure 3.

The telescope unit 1 in accordance with the present preferred embodiment is a binoculars comprising two telescopes 10;11 (each telescope holds an eyepiece and an objective lens at two distal ends; because the structure of the telescopes is of the known art, no further detailed description is necessary), and a frame 12 joining the telescopes 10;11. The digital camera 2 is provided at the bottom side of the telescope unit 1, comprising a lens 20 disposed in the rear side thereof and adapted for focusing the image of the field viewed, and a shutter release 21 for controlling the action of taking the photo of the field viewed.

The detachable coupling structure 3 is adapted for securing the digital camera 2 to the telescope unit 1. When unfastened the detachable coupling structure 3, the digital camera 2 and the telescope unit 1, can be separately used.

According to the present preferred embodiment, the detachable coupling structure 3 comprises a hook member 30 fixedly provided at the bottom side of the frame 12 of the telescope unit 1, and a hook hole 31 formed in the top sidewall of the digital camera 2. The hook member 30 has a front hooked portion 32. When connecting the digital camera 2 and the telescope unit 1 together, attach the digital camera 2 to the telescope unit 1, keeping the hook member 30 inserted into the hook hole 31, and then move the telescope unit 1 forwards relative to the digital camera 2 to force the front hooked portion 32 into engagement with the peripheral wall of the hook hole 31.

On the contrary, when separating the telescope unit 1 and the digital camera 2, move the telescope unit 1 backwards relative to the digital camera 2 to disengage the front hooked portion 32 of the hook member 30 from the peripheral wall of the hook hole 31.

Referring to FIGS. from 1 through 3 again, the telescope unit 1 and the digital camera 2 are detachably fastened together by the detachable coupling structure 3, the user can use the digital camera 2 with the telescope unit 1 together. By means of the telescope unit 1, the user can see the image of the field clearly at a distance. When viewing the image of the field at a distance, the user can take photos of the field by the digital camera 2.

A protocol of detachable telescope camera has been constructed with the features of the annexed drawings of FIGS. 1˜3. The detachable telescope camera functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A detachable telescope camera comprising a telescope unit adapted for viewing the field at a distance, a digital camera, and a detachable coupling structure adapted for detachably securing said digital camera to said telescope unit at a bottom side for taking photos of the field viewed through said telescope unit.

2. The detachable telescope camera as claimed in claim 1, wherein said telescope unit is a binocular.

3. The detachable telescope camera as claimed in claim 1, said telescope unit comprises two telescopes and a frame joining said telescopes.

4. The detachable telescope camera as claimed in claim 1, wherein said digital camera comprises a lens disposed in a rear side thereof and adapted for focusing the image of the object viewed, and a shutter release adapted for controlling the action of taking the photo of the field viewed.

5. The detachable telescope camera as claimed in claim 1, wherein said detachable coupling structure comprises a hook member fixedly provided at a bottom side of said telescope unit, said hook member having a front hooked portion, and a hook hole formed in a top sidewall of said digital camera and adapted for receiving said hook member.
